(19) United States
(12) Patent Application Publication
(10) Pub. No.: US 2026/0075553 A1
(43) Pub. Date: Mar. 12, 2026

(54) COMMUNICATION METHOD, TERMINAL DEVICE, AND NETWORK DEVICE

(71) Applicant: QUECTEL WIRELESS SOLUTIONS CO., LTD., Shanghai (CN)

(72) Inventor: Zheng ZHAO, Shanghai (CN)

(21) Appl. No.: 19/388,317

(22) Filed: Nov. 13, 2025

Related U.S. Application Data
(63) Continuation of application No. PCT/CN2024/098280, filed on Jun. 7, 2024.

(51) Int. Cl. H04W 56/00; H04W 48/08

(52) U.S. Cl. CPC H04W 56/001; H04W 48/08

(57) ABSTRACT

Provided are a communication method, a terminal device, and a network device. One example communication method includes: receiving first information from a network device, wherein the first information comprises synchronization signal/physical broadcast channel block (SSB)-based measurement timing configuration (SMTC); and using the SMTC to detect an on-demand SSB.

### CROSS-REFERENCE TO RELATED APPLICATIONS

This application is a continuation of International Application No. PCT/CN2024/098280, filed on Jun. 7, 2024, the disclosure of which is hereby incorporated by reference in its entirety.

### TECHNICAL FIELD

The present application relates to the field of communications technologies, and more specifically, to a communication method, a terminal device, and a network device.

### BACKGROUND

Before cell configuration, a terminal device needs to perform cell measurement by using a synchronization signal/physical broadcast channel block (SS/PBCH block, SSB). The SSB is crucial for the terminal device to detect and synchronize a cell in a cellular network and may affect a communication network. Therefore, how to improve detection performance of the SSB becomes a problem that needs to be resolved.

### SUMMARY

The present application provides a communication method, a terminal device, and a network device. Various aspects used in the present application are described below.

According to a first aspect, a communication method is provided, including: receiving, by a terminal device, first information transmitted by a network device, where the first information includes SSB-based measurement timing configuration (SSB-based measurement timing configuration, SMTC), and the SMTC is used to detect an on-demand SSB.

According to a second aspect, a communication method is provided, including:
transmitting, by a network device, first information to a terminal device, where the first information includes SSB-based measurement timing configuration SMTC, and the SMTC is used to detect an on-demand SSB.

According to a third aspect, a terminal device is provided, including: a receiving unit, receiving first information transmitted by a network device, where the first information includes SSB-based measurement timing configuration SMTC, and the SMTC is used to detect an on-demand SSB.

According to a fourth aspect, a network device is provided, including: a transmission unit, configured to transmit first information to a terminal device, where the first information includes SSB-based measurement timing configuration SMTC, and the SMTC is used to detect an on-demand SSB.

According to a fifth aspect, a terminal device is provided, including a processor, a memory, and a transceiver. The memory is configured to store one or more computer programs. The processor is configured to invoke the computer program in the memory, to cause the terminal device to perform a part or all of the steps in the method according to the first aspect.

According to a sixth aspect, a network device is provided, including a processor, a memory, and a transceiver. The memory is configured to store one or more computer programs. The processor is configured to invoke the computer program in the memory, to cause the network device to perform a part or all of the steps in the method according to the second aspect.

According to a seventh aspect, an embodiment of the present application provides a communications system, where the communications system includes the terminal device and/or the network device described above. In some implementations, the communications system further includes another device that interacts with the terminal device and/or the network device in the solutions provided in embodiments of the present application.

According to an eighth aspect, an embodiment of the present application provides a computer-readable storage medium. The computer-readable storage medium stores a computer program, and the computer program causes a terminal device and/or a network device to perform a part or all of the steps in the methods according to the foregoing aspects.

According to a ninth aspect, an embodiment of the present application provides a computer program product. The computer program product includes a non-transitory computer-readable storage medium that stores a computer program, and the computer program is operable to cause a terminal device and/or a network device to perform a part or all of the steps in the methods according to the foregoing aspects. In some implementations, the computer program product may be a software installation package.

According to a tenth aspect, an embodiment of the present application provides a chip. The chip includes a memory and a processor, and the processor may invoke a computer program from the memory and run the computer program, to implement a part or all of the steps of the methods according to the foregoing aspects.

In embodiments of the present application, the network device transmits the first information to the terminal device, and the first information includes the STMC. Because the SMTC may be used to detect the on-demand SSB, the terminal device may perform a measurement operation on the on-demand SSB by using the SMTC, thereby meeting a measurement requirement of the on-demand SSB.

### BRIEF DESCRIPTION OF THE DRAWINGS

FIG. 1 is a schematic diagram of a wireless communications system to which embodiments of the present application are applied.

FIG. 2 is a schematic flowchart of a communication method according to an embodiment of the present application.

FIG. 3 is a schematic flowchart of a communication method according to another embodiment of the present application.

FIG. 4 is a schematic block diagram of a terminal device according to an embodiment of the present application.

FIG. 5 is a schematic block diagram of a network device according to an embodiment of the present application.

FIG. 6 is a schematic block diagram of an apparatus for communication according to an embodiment of the present application.

### DETAILED DESCRIPTION OF THE EMBODIMENTS

### Communications System

The technical solutions in the present application are described below with reference to the accompanying drawings. For ease of understanding, communication terms and communication processes that may be used in embodiments of the present application are first described with reference to FIG. 1.

FIG. 1 is a wireless communications system 100 to which embodiments of the present application are applied. The wireless communications system 100 may include a network device 110 and a terminal device 120. The network device 110 may provide communication coverage for a specific geographic area, and may communicate with the terminal device 120 located within the coverage.

FIG. 1 exemplarily shows one network device 110 and two terminal devices 120. Optionally, the wireless communications system 100 may include a plurality of network devices 110, and another quantity of terminal devices 120 may be included within coverage of each network device 110. In addition, optionally, the wireless communications system 100 may further include other network entities such as a network controller and a mobility management entity.

The terminal device in embodiments of the present application may alternatively be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal device, a wireless communications device, a user agent, or a user apparatus. For example, the terminal device may be a device providing a user with voice and/or data connectivity and capable of connecting people, objects, and machines, such as a household appliance, a sensor, and an electronic tag having a wireless connection function. The terminal device may further be a wireless terminal in a smart home (smart home), a wireless terminal in an IWSN, a wireless terminal in smart logistics and smart warehousing, a wireless terminal in self driving (self driving), a wireless terminal in a remote medical surgery (remote medical surgery), a wireless terminal in a smart grid (smart grid), a wireless terminal in transportation safety (transportation safety), a wireless terminal in a smart city (smart city), or the like.

The network device may be a device configured to communicate with the terminal device. The network device may alternatively be an access network device or a radio access network device. For example, the network device may be a base station. The network device in embodiments of the present application may be a radio access network (radio access network, RAN) node (or device) that connects the terminal device to a wireless network. The base station may broadly cover the following various names, or may be interchanged with the following names: a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a baseband unit (baseband unit, BBU), a remote radio unit (remote radio unit, RRU), an active antenna unit (active antenna unit, AAU), a remote radio head (remote radio head, RRH), a centralized unit (centralized unit, CU), a distributed unit (distributed unit, DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device form used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

In some deployments, the network device may be a CU or a DU; or the network device includes a CU and a DU. Optionally, the gNB may include an AAU.

It should be understood that all or some of functions of the communications device in the present application may also be implemented by software functions running on hardware, or by virtualization functions instantiated on a platform (for example, a cloud platform).

### Carrier Aggregation

The carrier aggregation (carrier aggregation, CA) is a technology for increasing a data transmission rate of a wireless communications system. A plurality of carrier spectrum resources are combined, to increase a total bandwidth to increase a peak data rate of a user in an uplink and a downlink. The CA can be used in scenarios involving a same frequency range and different frequency ranges are used. In the same frequency range CA, component carriers (component carrier, CC) belonging to the same frequency range are aggregated together, and the frequency range may be one of a frequency range FR1 or a frequency range FR2. In the different frequency ranges CA, CCs belonging to the different frequency ranges are aggregated together, and the different frequency ranges may include a frequency range FR1, a frequency range FR2, and the like.

The CA allows two or more adjacent or non-adjacent CCs to be aggregated to form a wider bandwidth resource, to jointly schedule data for a user. For example, if a bandwidth of each carrier is 20 MHz, a bandwidth of 100 MHz may be obtained by aggregating five such carriers, thereby significantly increasing a data transmission rate. The CA may be classified based on a distribution and combination manner of spectrum resources, and the like. For example, the CA may include the following types: intra-band contiguous CA (intra-band contiguous CA), that is, aggregated carriers are in a same frequency range and are contiguous; intra-band non-contiguous CA (intra-band non-contiguous CA), that is, aggregated carriers are in a same frequency band but not contiguous; and inter-band CA (inter-band CA), that is, aggregated carriers are in different frequency ranges.

The data transmission rate of the user may be significantly increased by increasing an effective bandwidth, and the system may support more users and a higher throughput. The CA may effectively utilize scattered spectrum resources, to increase a utilization rate of the spectrum resources. In some scenarios, aggregating carriers in different frequency ranges may improve network coverage performance.

Implementation of the CA requires a plurality of technical links, such as scheduling and resource management, a hardware design with multi-carrier support, and signal processing. Based on a user requirement and a network condition, the system using the CA dynamically allocates and manages aggregated carriers, and a terminal device and a network device need to support a multi-carrier transceiver function.

In a mobile broadband (mobile broadband, MBB) scenario, user experience may be improved by using the CA, especially in scenarios with a high data rate requirement, such as high-definition video streaming and an online game. In some large-scale internet of things (internet of things, IoT) applications, the CA is beneficial to increasing a network capacity and coverage. In short, the CA provides enterprise users with highly reliable and high-speed wireless network connections.

### SSB

The SSB plays an important role in aspects such as initial access and synchronization of a terminal device and obtaining of broadcast information of a cell, for example, carrying cell identity (identity, ID), performing time-frequency synchronization, indicating symbol level/slot level/frame timing, beam signal strength/signal quality measurement, and cell signal strength/signal quality measurement. For example, the cell signal strength/signal quality measurement may include radio resource management (radio resource management, RRM) measurement/channel state information (channel state information, CSI) measurement. The beam signal strength/signal quality measurement may be used to perform beam selection, beam fault detection, beam fault recovery, and the like.

The SSB includes a part or all of information such as a primary synchronization signal (primary synchronization signal, PSS), a secondary synchronization signal (secondary synchronization signal, SSS), a physical broadcast channel (physical broadcast channel, PBCH), and a demodulation reference signal (demodulation reference signal, DMRS). A master information block (master information block, MIB) is carried on the PBCH, and the MIB information may include a control resource set (control resource SET, CORESET) corresponding to search space of a physical downlink control channel (physical downlink control channel, PDCCH). The PDCCH is a PDCCH in a type-0 format, and is used to carry a system information block (system information block, SIB) 1. The terminal device may determine the PDCCH based on the MIB information, to obtain the SIBI on a corresponding physical downlink shared channel (physical downlink shared channel, PDSCH) based on the PDCCH. The SIBI provides key information required by the terminal device during initial access and a normal operation, so that it can be ensured that the terminal device correctly performs correctly synchronization, selects a suitable cell, performs random access, and obtains a basic configuration parameter of the network. The terminal device may communicate with the network device efficiently by using the SIBI, to ensure a stable and reliable connection. The SIBI includes key system information required by the terminal device to access the network, such as public land mobile network (Public Land Mobile Network, PLMN) information, cell selection information, time and frequency information, an access parameter, power control information, cell broadcast information, public alarm information, and other information. For example, other information includes cell access restriction and registration area related information.

### SSB Transmission Manner

In a CA scenario, in addition to a primary cell (primary cell, PCell), a system further configures one or more secondary cells (secondary cell, SCell). The cells together provide users with a higher data rate and better coverage.

In a 5G next radio (next radio, NR) system, an SSB is usually not transmitted on the SCell. The SSB is mainly transmitted on the PCell, while the SSB does not need to be transmitted on the SCell because the terminal device may perform synchronization and initial access by using the SSB on the PCell. When the terminal device completes synchronization and initial access by using the SSB on the PCell, the SCell may be configured and activated by using radio resource control (radio resource control, RRC) signalling, a medium access control (medium access control, MAC) control element (control element, CE), or the like, thereby providing flexible CA and cell management. For example, the SCell is added, modified, or released through RRC connection reconfiguration (RRC connection reconfiguration). For another example, the SCell is activated or deactivated by using the MAC CE. In this way, in a case of limited spectrum resources, unnecessary SSB transmission may be reduced, thereby increasing spectrum efficiency and reducing power consumption of the network device and the terminal device, especially the power consumption of the network device.

Although the SSB is usually not transmitted on the SCell, the SSB may need to be transmitted on the SCell in some specific scenarios. For example, in some standalone deployment (standalone deployment) scenarios, the SSB may need to be transmitted on the SCell to support synchronization and access of the terminal device. For another example, in some complex switching scenarios, transmitting the SSB on the SCell may be beneficial to completing inter-cell switching more smoothly by the terminal device.

### Cell Measurement

Before an SCell is configured for a terminal device, the terminal device considers the SCell as a neighboring cell and measures the neighboring cell. During the measurement of the neighboring cell, the terminal device first needs to identify and measure signal strength and quality of the neighboring cell. The measurement is beneficial to the network device determining whether to configure a cell as the SCell of the terminal device. The terminal device scans a spectrum to find all possible neighboring cells, and measures signal strength, for example, a reference signal received power (reference signal received power, RSRP), and signal quality, such as reference signal received quality (reference signal received quality, RSRQ) and a signal to interference plus noise ratio (signal to interference plus noise ratio, SINR), of the found neighboring cells. To perform the measurement, the terminal device needs to perform an operation based on specific timing and configuration. This is SMTC. The SMTC defines a measurement period, a measurement window (measurement window), an SSB time-frequency position, and an offset (offset) of the measurement window relative to a reference time in a measurement object (measurement object, MO). The terminal device performs measurement based on a range, such as a corresponding time interval, time period, frequency range, or offset, to ensure that the measurement operation does not conflict with an activity of another terminal device. In other words, the terminal device needs to measure the neighboring cell based on the SMTC corresponding to the MO.

The MO is used to indicate an object and a parameter that are to be measured, such as a frequency range and a cell that need to be measured by the terminal device. The MO includes SSB measurement configuration, for example, the SMTC, and the SSB measurement configuration is used to indicate how the terminal device performs SSB measurement. The SMTC includes an SSB measurement time sequence, for example, a parameter such as a measurement period, a measurement time window, and a measurement start time for the terminal device to perform SSB measurement.

When the terminal device performs SSB measurement on the neighboring cell, the terminal device receives an MO transmitted by the network device and obtains SMTC in the MO. The network device may transmit the MO and the SMTC to the terminal device by using, for example, RRC signalling. After obtaining the SMTC, the terminal device performs frequency scanning, that is, scanning the neighboring cell based on obtained frequency information. Next, the terminal device performs measurement within a specified time period, that is, performs SSB measurement within a specified measurement window based on a specified measurement period a according to configuration in the SMTC. After the measurement is completed, the terminal device reports a measurement result to the network device, and the network device determines, based on the measurement result, whether to configure the cell as the SCell of the terminal device.

As an example, the MO and the specific configuration of the SMTC that are transmitted by the network device to the terminal device may include parameters and content corresponding to the parameters shown in Table 1.

TABLE 1

| MO | SMTC |
|---|---|
| Measurement frequency | n78 (a frequency range of 3.5 GHz) |
| Measurement period | 20 ms |
| Measurement window | 5 ms |
| Offset | 4 ms |

As shown in Table 1, after receiving the configuration information, the terminal device starts measurement every 20 ms, and performs SSB measurement within next 5 ms, to measure signal strength and quality of all neighboring cells in the frequency range of n78.

In a 5G NR network, before an SCell is configured, the terminal device needs to first consider the Scell as a neighboring cell and perform SSB measurement. This process is defined by the SMTC in the MO. For example, information such as the measurement period, the measurement window, the measurement frequency, and the offset. Through the measurement, the network device determines whether to configure the cell as the SCell of the terminal device, thereby optimizing network performance and user experience.

In the 5G NR network, in a process of configuring and activating the SCell, for example, from cell discovery and cell measurement to cell configuration and activation, a plurality of steps are performed in a process from the network device configuring an instruction to the terminal device performing a specific operation. As an example, the configuring and activating the SCell may include a part or all of the following steps.

In Step 1, measure the neighbor cell.

Before the SCell is configured, the terminal device first needs to discover and measure the neighboring cell. The terminal device obtains the MO. For example, the network device transmits the MO to the terminal device by using RRC signalling, to specify to-be-measured information such as a frequency range and a cell. The MO includes the SMTC that is used to instruct the terminal device to perform SSB measurement on the neighboring cell in a specific time window. The terminal device performs SSB measurement on the neighboring cell based on the MO and the SMTC, and collects information such as signal strength, for example, an RSRP, and signal quality, such as RSRQ and an SINR. The terminal device reports measurement results to the network device, so that the network device makes a cell configuration decision based on the results.

In Step 2, configure the SCell.

The network device transmits an RRC connection reconfiguration message to the terminal device. The RRC connection reconfiguration message includes configuration information of the SCell, such as a frequency range and a bandwidth of the SCell, a physical cell identity (PCI) of the SCell, and downlink and uplink configuration of the SCell. After receiving the RRC connection reconfiguration message, the terminal device configures a related parameter of the SCell based on the information in the RRC connection reconfiguration message.

In Step 3, activate/deactivate the SCell.

After configuration of the SCell is completed, the network device may dynamically activate or deactivate the SCell as required, to optimize resource utilization and user experience. An activation and deactivation process is implemented by using a MAC CE. The MAC CE is special control signalling used to transfer control information of a MAC layer. A processing delay of the MAC CE is less than control signalling of an RRC layer, so that the SCell can be activated relatively fast.

After receiving an activation command, the terminal device starts data transmission on the SCell, including starting physical layer processing and resource scheduling of the SCell.

When determining that the SCell is no longer required, the network device transmits a deactivation command to the terminal device by using the MAC CE. After receiving the deactivation command, the terminal device stops data transmission on the SCell and releases a related resource.

The configuration and activation processes of the SCell is part of the CA in 5G NR, and aim to optimize utilization of a spectrum resource and improve network performance and user experience. By measuring the neighbor cell, configuring the SCell parameter, and dynamically activating and deactivating the SCell, the network device can flexibly manage the spectrum resource, and provide a higher data transmission rate and better service quality. This is crucial for optimizing network deployment and operation and meeting a user requirement.

The network device may periodically transmit the SSB, to synchronize the terminal device with the network device or a serving cell, or to perform cell measurement. For the terminal device, it cannot be ensured that an SSB transmitted on the SCell each time is effectively used, thereby leading to a waste of resources.

For this reason, an on-demand SSB (on demand SSB) is provided. Different from the periodically transmitted SSB, the on-demand SSB is transmitted only within a time period. For example, the on-demand SSB may be used in two situations. In one situation, the network device transmits the SSB within a time period for the terminal device to perform SSB detection, and the network device may indicate information about the time period to the terminal device by using control signalling such as RRC signalling or a MAC CE. In another situation, the terminal device requests an SSB from the network device on demand, and the network device may transmit the SSB based on the request from the terminal device. In this way, wasted resources may be reduced.

To meet a measurement requirement of the on-demand SSB, an embodiment of the present application provides a communication method. SSB type indication information used to indicate whether an SSB is the on-demand SSB is added in STMC, so that a terminal device identifies the SMTC for the on-demand SSB, and performs a measurement operation on the on-demand SSB based on the SMTC.

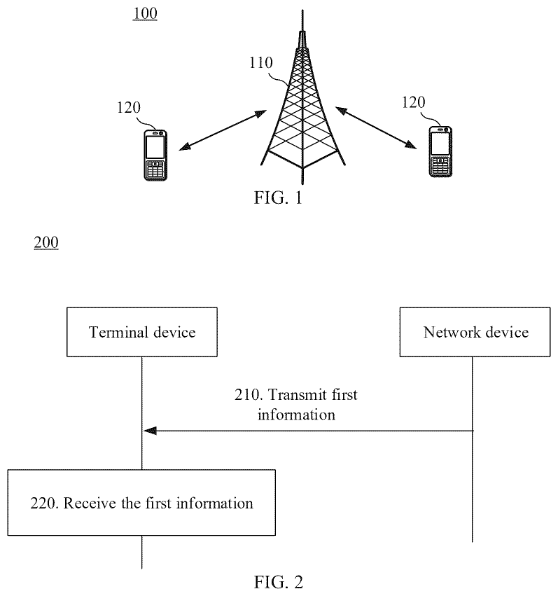

FIG. 2 is a schematic flowchart of a communication method according to an embodiment of the present application. The method 200 shown in FIG. 2 may be performed by a terminal device and a network device. As shown in FIG. 2, the method 200 includes a part or all of the following steps.

In Step 210, the network device transmits first information to the terminal device.

Correspondingly, in Step 220, the terminal device receives the first information transmitted by the network device.

The first information includes SMTC. For example, the first information is carried in RRC signalling. For another example, the first information is an MO, and the MO includes the SMTC.

In embodiments of the present application, the SMTC may be used to detect an on-demand SSB. Therefore, the terminal device may perform a measurement operation on the on-demand SSB by using the SMTC, thereby meeting a measurement requirement of the on-demand SSB.

In some implementations, the terminal device may further receive SSB type indication information. The SSB type indication information is used to indicate whether the SMTC is for detection of the on-demand SSB, or the SSB type indication information is used to indicate whether the SMTC is used to detect the on-demand SSB. For example, when the SSB type indication information is different values, the SSB type indication information may represent different SSB types. For example, when the SSB type indication information is 1 or YES, it indicates that the SMTC is for the detection of the on-demand SSB. When the SSB type indication information is 0 or NO, it indicates that the SMTC is not for the detection of the on-demand SSB.

Optionally, the SSB type indication information is carried in the first information, in other words, the first information includes the SSB type indication information. In this case, the SSB type indication information and the SMTC are both carried in the first information. Alternatively, the SSB type indication information may be carried in another piece of signalling, for example, another piece of RRC signalling related to the on-demand SSB.

The terminal device may determine, based on on-demand SSB type indication information, whether the SMTC is used to detect the on-demand SSB, thereby identifying the SMTC for the on-demand SSB, to perform the measurement operation on the on-demand SSB by using the SMTC.

When the SSB type indication information indicates that the SMTC is used to detect the on-demand SSB and a cell is not configured, the cell may be measured by using the SMTC. As an example, an example in which the first information is an MO is used. After the SMTC for the on-demand SSB is added in configuration in the MO, specific content of the configuration in the MO may be as follows.

| | |
|---|---|
| MeasObjectNR ::= | SEQUENCE { |
| ssbFrequency | ARFCN-ValueNR |
| OPTIONAL, -- Cond SSBorAssociatedSSB | |
| ssbSubcarrierSpacing | SubcarrierSpacing |
| OPTIONAL, -- Cond SSBorAssociatedSSB | |
| smtc1 | SSB-MTC |
| OPTIONAL, -- Cond SSBorAssociatedSSB | |
| smtc2 | SSB-MTC2 |
| OPTIONAL, -- Cond SSBorAssociatedSSB | |
| smtc-on-demand-SSB | SSB-MTC-On-demand-SSB |
| OPTIONAL, -- Cond IntraFreqConnected | |
| refFreqCSI-RS | ARFCN-ValueNR |
| OPTIONAL, -- Cond CSI-RS | |
| referenceSignalConfig | ReferenceSignalConfig, |
| absThreshSS-BlocksConsolidation | ThresholdNR |
| OPTIONAL, -- Need R | |
| absThreshCSI-RS-Consolidation | ThresholdNR |
| OPTIONAL, -- Need R | |
| nrofSS-BlocksToAverage | INTEGER (2..maxNrofSS- |
| BlocksToAverage) | OPTIONAL, -- Need R |
| nrofCSI-RS-ResourcesToAverage | INTEGER (2..maxNrofCSI-RS- |
| ResourcesToAverage) | OPTIONAL, -- Need R |

Before the network device configures the cell to the terminal device, the terminal device considers the cell as a neighboring cell, and the terminal device needs to measure the cell based on the SMTC in the received first information. Optionally, the SMTC may further include one or more of the following information: a measurement period of an SSB, a measurement window of the SSB, a measurement frequency of the SSB, and an offset of the measurement window relative to a reference time.

The measurement period in the SMTC is used to indicate how long the terminal device needs to perform SSB measurement once. For example, common measurement periods include 20 milliseconds and 40 milliseconds. Information of the measurement frequency in the SMTC is frequency range information, and is used to indicate a frequency range in which the terminal device is required to perform SSB measurement. The SSB measurement may relate to one or more frequency ranges. The measurement window in the SMTC is used to indicate a specific time period, within the measurement period, during which the terminal device performs SSB measurement. In addition, to reduce impact on another operation by the terminal device, a length of the measurement window may usually be set to be relatively short. The SSB offset value in the SMTC is used to indicate an offset of the measurement window of the SSB relative to a reference time, so that the measurement window is aligned with a transmission time of the SSB.

As an example, specific content of the first information may be as follows. An example in which the measurement period is 20 ms, the measurement window is 5 ms, the measurement frequency is 36000 Hz, and the offset is 4 is used herein. In addition, the SSB type indication information (ssbType) used to indicate whether the SMTC is for the on-demand SSB is added in the SMTC.

```
RRCConnectionReconfiguration {
  measurementObject {
    ssbMeasurementTimingConfiguration {
      measurementPeriodicity: ms20,
      measurementWindow: ms5,
      frequency: 36000,
      ssbOffset: 4
ssbType: On-demand SSB or not
    }
  }
}
```

When being switched from one cell to another, the terminal device no longer needs to perform SSB measurement on a previous cell. Alternatively, in a case in which the network device determines to stop using a cell and the like, the network device maliciously instructs the terminal device to stop using the current SMTC for SSB measurement, thereby releasing a related resource. In a related technology, the network device may transmit RRC signalling to the terminal device, to notify the terminal device to stop using the current SMTC for SSB measurement. As an example, specific content of the RRC signalling may be as follows:

RRCConnectionReconfiguration {
releaseSMTC: true
}

After receiving the RRC signalling, the terminal device stops measurement that is based on current SMTC configuration, and releases a resource related to the SMTC, for example, stops a related measurement timer and a process.

After the SMTC is configured, if the SMTC is to be ended by using the RRC signalling, because a RRC signalling packet is relatively large, relatively many network resources need to be consumed. In addition, a relatively long processing delay of control signalling of an RRC layer may cause the terminal device to fail to release the resource of the SMTC in time, thereby affecting network performance.

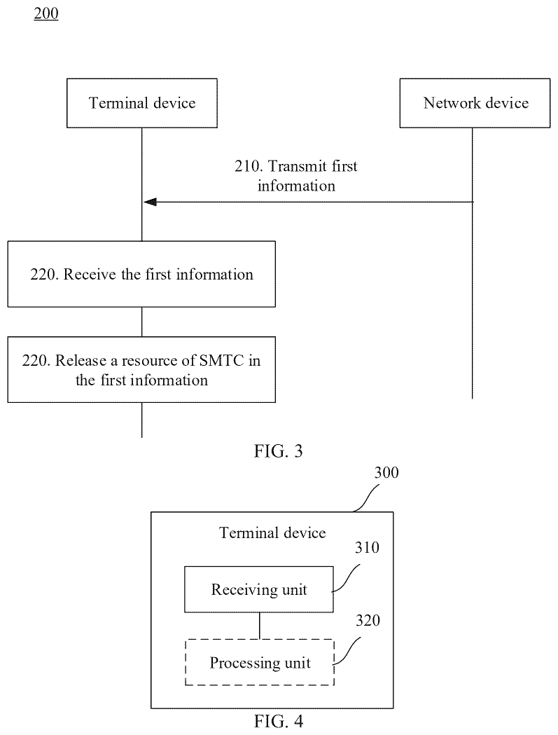

Since the on-demand SSB is transmitted within a time period, in some implementations, for example, as shown in FIG. 3, the method 200 may further include Step 230.

In Step 230, the terminal device releases the resource of the SMTC based on transmission of the on-demand SSB.

Several manners of releasing the resource of the SMTC are provided below, thereby reducing the delay and saving network resources. Herein, releasing the resource of the SMTC means, for example, stopping using the resource of the SMTC for detecting the SSB.

### Manner 1

The terminal device may release the resource of the SMTC when the transmission of the on-demand SSB is ended. Because the transmission of the on-demand SSB falls within a time period, the terminal device may release the resource of the SMTC when the transmission of the on-demand SSB is ended.

Optionally, the terminal device may determine, based on signalling that is transmitted by the network device and that is related to the on-demand SSB, whether the transmission of the on-demand SSB is ended.

For example, the network device may transmit third information to the terminal device, and the third information is used to indicate a transmission end time of the on-demand SSB. The third information is further used to instruct the terminal device to release the resource of the SMTC, such as a frequency resource and/or a time resource occupied by the SMTC. Correspondingly, when receiving the third information, the terminal device may release the resource of the SMTC when the transmission of the on-demand SSB is ended or when preset duration used after the transmission of the on-demand SSB is ended ends. The preset duration may be, for example, agreed upon by a protocol or transmitted by the network device.

### Manner 2

The network device may transmit second information to the terminal device.

Correspondingly, the terminal device receives the second information transmitted by the network device. The second information is used to instruct to activate a current cell. For example, the second information may be a MAC CE.

In this implementation, the second information is further used to instruct the terminal device to release the resource of the SMTC, such as a frequency resource and/or a time resource occupied by the SMTC. When the terminal device detects the SSB based on the SMTC, in a case in which the SMTC is for the on-demand SSB, the terminal device may end the corresponding SMTC based on an activation status of the current cell and release the resource of the SMTC. This is because activation of the cell indicates that configuration of the cell is completed, that is, the terminal device may complete detection of the SSB and report a measurement result to the network device, and the network device configures the cell to the terminal device. In this case, the terminal device may not need to detect the SSB, and therefore may release the resource of the SMTC without waiting for RRC signalling used to instruct the terminal device to release the SMTC to release the resource of the SMTC. This allows the terminal device to release an unnecessary resource in time and saves network resources.

### Manner 3

The first information may further include measurement time information, and the measurement time information is used to instruct the terminal device to release a resource of the SMTC, such as a frequency resource and/or a time resource occupied by the SMTC.

The terminal device may end the corresponding SMTC based on the measurement time information in the first information, and release the resource of the SMTC without waiting for RRC signalling used to instruct the terminal device to release the SMTC to release the resource of the SMTC, so that the terminal device releases an unnecessary resource in time, thereby saving network resources.

The measurement time information may be pre-agreed, for example, specified by a protocol, may be configured by using higher layer signalling, or may be calculated by the terminal device based on related information.

In some implementations, the measurement time information may include a quantity of measurement periods of an on-demand SSB.

For example, the quantity of measurement periods is determined based on transmission duration and duration of the measurement period of the on-demand SSB.

Assuming that the quantity of measurement periods in the measurement time information is N, the terminal device determines to end SSB detection that is based on the SMTC after N periods of SSB detection. If the transmission duration of the on-demand SSB is M, that is, the on-demand SSB is ended after the transmission duration M, N may be determined based on M and the measurement period of the on-demand SSB, for example, N is equal to M divided by a length of the measurement period of the on-demand SSB.

For another example, the quantity of measurement periods is determined based on a maximum quantity of SSBs for combined detection.

Assuming that the quantity of measurement periods in the measurement time information is N, and the terminal device supports combined detection of up to 4 SSBs when performing SSB detection, N may be set to 4. During the combined detection, a detection result of a previous SSB can be used for detecting a subsequent SSB. For example, when a maximum quantity of SSBs is 8, an SSB 0 to an SSB 3 may be combined for detection, or an SSB 4 to an SSB 7 may be combined for detection.

A value of N may be a constant, or may change with a change in other information.

In some other implementations, the measurement time information may directly include effective duration of the SMTC.

For example, the effective duration of the SMTC may be determined based on the transmission duration of the on-demand SSB. Transmission of the on-demand SSB is stopped after transmission within a time period. After measurement of the on-demand SSB is ended, the terminal device may release the resource of the SMTC. Therefore, the effective duration of the SMTC may be equal to the transmission duration of the on-demand SSB.

For another example, the effective duration of the SMTC is determined based on the measurement period of the on-demand SSB and the maximum quantity of SSBs for combined detection. Assuming that the quantity of measurement periods of the on-demand SSB is N, and the terminal device supports combined detection of up to 4 SSBs when performing SSB detection, the effective duration of the SMTC may be 4 N.

As an example, specific content of the first information may be as follows. An example in which the measurement period is 20 ms, the measurement window is 5 ms, the measurement frequency is 36000 Hz, and the offset is 4 is used herein. In addition, the measurement time information is added to the SMTC, such as the quantity of measurement periods or the effective duration of the SMTC.

```
RCConnectionReconfiguration {
  measurementObject {
    ssbMeasurementTimingConfiguration {
      measurementPeriodicity: ms20,
      measurementWindow: ms5,
      frequency: 36000
      ssbOffset: 4
      measurementTime: Quantity of measurement periods/Effective
duration of the SMTC
    }
  }
}
```

It should be noted that, in embodiments of the present application, the first information may include both the SSB type indication information and the measurement time information; may include only one of the SSB type indication information and the measurement time information; or does not include the SSB type indication information or the measurement time information. However, it is determined, in another manner, whether the SMTC in the first information is used to detect the on-demand SSB and when to release the resource of the SMTC.

For example, the first information includes the SSB type indication information but does not include the measurement time information. The terminal device determines, based on the SSB type indication information, whether the SMTC in the first information is for the on-demand SSB, and when to release the resource of the SMTC is determined in another manner when the SMTC is for the on-demand SSB, for example, based on the RRC signalling transmitted by the network device, the transmission end time of the on-demand SSB, or the second information mentioned above.

For another example, the first information includes the measurement time information but does not include the SSB type indication information. The terminal device may determine, in another manner, whether the SMTC in the first information is for the on-demand SSB, and when the SMTC is for the on-demand SSB, determine, based on the measurement time information in the first information, when to release the resource of the SMTC.

For another example, the first information includes the SSB type indication information and the measurement time information. The terminal device determines, based on the SSB type indication information, whether the SMTC in the first information is for the on-demand SSB, and when the SMTC is for the on-demand SSB, releases the resource of the SMTC after duration indicated by the measurement time information in the first information ends.

Certainly, the first information may alternatively not include the SSB type indication information and/or the measurement time information. However, it is determined, in another manner, whether the SMTC in the first information is used to detect the on-demand SSB and when to release the resource of the SMTC.

As an example, specific content of the first information is as follows. An example in which the measurement period is 20 ms, the measurement window is 5 ms, the measurement frequency is 36000 Hz, and the offset is 4 is used herein. In addition, an example in which the first information includes the SSB type indication information and the measurement time information is used.

```
  RCConnectionReconfiguration {
    measurementObject {
      ssbMeasurementTimingConfiguration {
        measurementPeriodicity: ms20,
        measurementWindow: ms5,
        frequency: 36000
        ssbOffset: 4
        ssbType: On-demand SSB or not
  measurementTime: Quantity of measurement periods/Effective duration of the
SMTC
      }
    }
  }
```

The method embodiments of the present application are described above in detail with reference to FIG. 2 and FIG. 3. Apparatus embodiments of the present application are described below in detail with reference to FIG. 4 to FIG. 6. It should be understood that the descriptions of the method embodiments correspond to the descriptions of the apparatus embodiments, and therefore, for a part that is not described in detail, reference may be made to the foregoing method embodiments.

FIG. 4 is a schematic diagram of a terminal device according to an embodiment of the present application. The terminal device 300 shown in FIG. 4 may include a receiving unit 310. Optionally, the terminal device 300 further includes a processing unit 320.

The receiving unit 310 is configured to receive first information transmitted by a network device, where the first information includes SMTC used for measuring a synchronization signal block SSB; and the first information further includes SSB type indication information, and the SSB type indication information is used to indicate whether the SMTC is for detection of an on-demand SSB.

In some implementations, the receiving unit 310 is further configured to receive the SSB type indication information, where the SSB type indication information is used to indicate that the SMTC is used to detect the on-demand SSB.

In some implementations, the SSB type indication information is carried in the first information.

In some implementations, the processing unit 320 is configured to release a resource of the SMTC based on transmission of the on-demand SSB.

In some implementations, the receiving unit 310 is further configured to receive second information transmitted by the network device, where the second information is used to instruct to activate a current cell. The processing unit 320 is further configured to release the resource of the SMTC based on the second information.

In some implementations, the receiving unit 310 is further configured to receive third information transmitted by the network device, where the third information is used to indicate a transmission end time of the on-demand SSB. The processing unit 320 is further configured to release, based on the third information, the resource of the SMTC when the transmission of the on-demand SSB is ended or when preset duration used after the transmission of the on-demand SSB is ended ends.

In some implementations, the first information further includes measurement time information, and the measurement time information is used to instruct the terminal device to release a resource of the SMTC.

In some implementations, the measurement time information includes a quantity of measurement periods of the on-demand SSB.

In some implementations, the quantity of measurement periods is determined based on transmission duration of the on-demand SSB and duration of the measurement period; or the quantity of measurement periods is determined based on a maximum quantity of SSBs for combined detection.

In some implementations, the measurement time information includes effective duration of the SMTC.

In some implementations, the effective duration of the SMTC is determined based on transmission duration of the on-demand SSB; or the effective duration of the SMTC is determined based on a measurement period of the on-demand SSB and a maximum quantity of SSBs for combined detection.

In some implementations, the first information is carried in radio resource control RRC signalling, and/or the first information is a measurement object MO.

In some implementations, the SMTC includes one or more of the following information: a measurement period of an SSB, a measurement window of the SSB, a measurement frequency of the SSB, and an offset of the measurement window relative to a reference time.

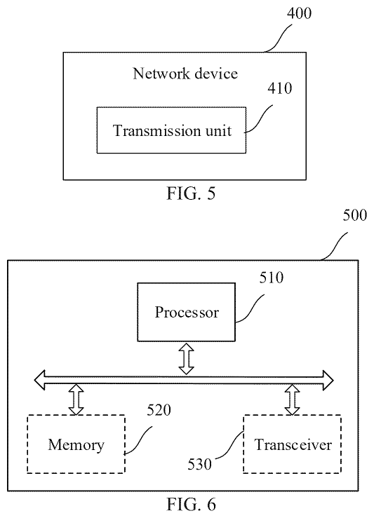

FIG. 5 is a schematic diagram of a network device according to an embodiment of the present application. The network device 400 shown in FIG. 5 includes a transmission unit 410.

The transmission unit 410 is configured to transmit first information to a terminal device, where the first information includes synchronization signal/physical broadcast channel block SSB-based measurement timing configuration SMTC, and the SMTC is used to detect an on-demand SSB.

In some implementations, the transmission unit 410 is further configured to transmit SSB type indication information to the terminal device, where the SSB type indication information is used to indicate that the SMTC is used to detect the on-demand SSB.

In some implementations, the SSB type indication information is carried in the first information.

In some implementations, the transmission unit 410 is further configured to transmit second information to the terminal device, where the second information is used to instruct to activate a current cell, and the second information is further used to instruct the terminal device to release a resource of the SMTC.

In some implementations, the transmission unit 410 is further configured to transmit third information to the terminal device, where the third information is used to indicate a transmission end time of the on-demand SSB, and the third information is further used to instruct the terminal device to release a resource of the SMTC.

In some implementations, the first information further includes measurement time information, and the measurement time information is used to instruct the terminal device to release a resource of the SMTC.

In some implementations, the measurement time information includes a quantity of measurement periods of the on-demand SSB.

In some implementations, the quantity of measurement periods is determined based on transmission duration of the on-demand SSB and duration of the measurement period; or the quantity of measurement periods is determined based on a maximum quantity of SSBs for combined detection.

In some implementations, the measurement time information includes effective duration of the SMTC.

In some implementations, the effective duration of the SMTC is determined based on transmission duration of the on-demand SSB; or the effective duration of the SMTC is determined based on a measurement period of the on-demand SSB and a maximum quantity of SSBs for combined detection.

In some implementations, the first information is carried in radio resource control RRC signalling, and/or the first information is a measurement object MO.

In some implementations, the SMTC includes one or more of the following information: a measurement period of an SSB, a measurement window of the SSB, a measurement frequency of the SSB, and an offset of the measurement window relative to a reference time.

It may be understood that the receiving unit 310 may be, for example, a transceiver 530 and the processing unit 320 may be, for example, a processor 510. In addition, optionally, the terminal device 300 may further include a memory 520. For details, refer to FIG. 6.

Similarly, the transmission unit 410 may be, for example, the transceiver 530. In addition, optionally, the network device 400 may further include the processor 510 and the memory 520. For details, refer to FIG. 6.

FIG. 6 is a schematic diagram of a structure of an apparatus for communication according to an embodiment of the present application. Dashed lines in FIG. 6 indicate that a unit or module is optional. The apparatus may be configured to implement the method described in the foregoing method embodiment. The apparatus may be, for example, a chip, a terminal device, or a network device.

As shown in FIG. 6, the apparatus 500 may include one or more processors 510. The processor 510 may support the apparatus 500 in implementing the method described in the foregoing method embodiments. The processor 510 may be a general-purpose processor or a dedicated processor. For example, the processor 510 may be a central processing unit (central processing unit, CPU). Alternatively, the processor 510 may further be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 500 may further include one or more memories 520. The memory 520 stores a program, and the program may be executed by the processor 510, so that the processor 510 executes the method described in the foregoing method embodiments. The memory 520 may be separate from or integrated into the processor 510.

The apparatus 500 may further include a transceiver 530. The processor 510 may communicate with another device or chip by using the transceiver 530. For example, the processor 510 may transmit data to and receive data from another device or chip through the transceiver 530.

An embodiment of the present application provides a communications system. The system includes the terminal device and/or network device described above. In some implementations, the system further includes another device that interacts with the terminal device and/or the network device.

An embodiment of the present application further provides a computer-readable storage medium for storing a program. The computer-readable storage medium may be applied to the terminal or the network device provided in embodiments of the present application, and the program causes a computer to execute a method executed by the terminal device or the network device in various embodiments of the present application.

An embodiment of the present application further provides a computer program product. The computer program product includes a program. The computer program product may be applied to a terminal or a network device provided in embodiments of the present application, and the program causes a computer to perform the method performed by the terminal device or the network device in various embodiments of the present application.

An embodiment of the present application further provides a computer program. The computer program may be applied to the terminal or the network device provided in embodiments of the present application, and the computer program causes a computer to perform the method performed by the terminal device or the network device in various embodiments of the present application.

It should be understood that the terms “system” and “network” in the present application may be used interchangeably. In addition, the terms used in the present application are only used to explain the specific embodiments of the present application, and are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In the embodiments of the present application, “indicate” mentioned herein may refer to a direct indication, or may refer to an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being pre-defined may refer to being defined in a protocol.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In the embodiments of the present application, the “include” may refer to direct inclusion, or may refer to indirect inclusion. Optionally, the term “include” mentioned in the embodiments of the present application may be replaced with “indicate” or “be used to determine”. For example, A including B may be replaced with that A indicates B, or A is used to determine B.

In embodiments of the present application, sequence numbers of the foregoing processes do not mean execution sequences. The execution sequences of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in another manners. For example, the foregoing described apparatus embodiments are merely examples. For example, the unit division is merely logical function division and may be another division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium, such as a floppy disk, a hard disk, or a magnetic tape, an optical medium, for example, a digital video disc (digital video disc, DVD), a semiconductor medium, for example, a solid state drive (solid state drive, SSD), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A communication method, comprising:
receiving, by a terminal device, first information from a network device, wherein the first information comprises synchronization signal/physical broadcast channel block (SSB)-based measurement timing configuration (SMTC); and
using the SMTC to detect an on-demand SSB.

2. The method according to claim 1, wherein the method further comprises:
receiving, by the terminal device, SSB type indication information, wherein the SSB type indication information indicates that the SMTC is used to detect the on-demand SSB.

3. The method according to claim 2, wherein the SSB type indication information is carried in the first information.

4. The method according to claim 1, wherein the method further comprises:
releasing, by the terminal device, a resource of the SMTC based on transmission of the on-demand SSB.

5. The method according to claim 4, wherein the method further comprises:
receiving, by the terminal device, second information transmitted by the network device, wherein the second information is used to instruct to activate a current cell, and the second information is further used to instruct the terminal device to release the resource of the SMTC.

6. The method according to claim 4, wherein the method further comprises:
releasing, by the terminal device, the resource of the SMTC when the transmission of the on-demand SSB is ended or when preset duration used after the transmission of the on-demand SSB is ended ends.

7. The method according to claim 1, wherein the first information further comprises measurement time information, and the measurement time information is used to instruct the terminal device to release a resource of the SMTC.

8. The method according to claim 7, wherein the measurement time information comprises a quantity of measurement periods of the on-demand SSB.

9. The method according to claim 8, wherein the quantity of measurement periods is determined based on transmission duration of the on-demand SSB and duration of the measurement period; or the quantity of measurement periods is determined based on a maximum quantity of SSBs for combined detection.

10. The method according to claim 7, wherein the measurement time information comprises effective duration of the SMTC.

11. The method according to claim 10, wherein the effective duration of the SMTC is determined based on transmission duration of the on-demand SSB; or the effective duration of the SMTC is determined based on a measurement period of the on-demand SSB and a maximum quantity of SSBs for combined detection.

12. The method according to claim 1, wherein the first information is carried in radio resource control (RRC) signalling, or the first information is a measurement object (MO).

13. The method according to claim 1, wherein the SMTC comprises one or more of the following information: a measurement period of an SSB, a measurement window of the SSB, a measurement frequency of the SSB, or an offset of the measurement window relative to a reference time.

14. A communication method, comprising:
transmitting, by a network device, first information to a terminal device, wherein the first information comprises synchronization signal/physical broadcast channel block (SSB)-based measurement timing configuration (SMTC), and the SMTC is used to detect an on-demand SSB.

15. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first information from a network device, wherein the first information comprises synchronization signal/physical broadcast channel block (SSB)-based measurement timing configuration (SMTC); and
using the SMTC to detect an on-demand SSB.

16. The apparatus according to claim 15, wherein the operations further comprise:
receiving SSB type indication information, wherein the SSB type indication information indicates that the SMTC is used to detect the on-demand SSB.

17. The apparatus according to claim 16, wherein the SSB type indication information is carried in the first information.

18. The apparatus according to claim 15, wherein the operations further comprise:
releasing a resource of the SMTC based on transmission of the on-demand SSB.

19. The apparatus according to claim 18, wherein the operations further comprise:
receiving second information transmitted by the network device, wherein the second information is used to instruct to activate a current cell, and the second information is further used to instruct to release the resource of the SMTC.

20. The apparatus according to claim 18, wherein the operations further comprise:
releasing the resource of the SMTC when the transmission of the on-demand SSB is ended or when preset duration used after the transmission of the on-demand SSB is ended ends.
